(19) United States
(12) Patent Application Publication
(10) Pub. No.: US 2009/0051849 A1
(43) Pub. Date: Feb. 26, 2009

(54) BACKLIGHT UNIT AND IMAGE DISPLAY MODULE FOR IMPROVING BRIGHTNESS UNIFORMITY, AND A METHOD FOR ARRANGING BACKLIGHT UNIT

(75) Inventors: Ju-seong HWANG, Cheonan-si (KR); Kun-ho CHO, Suwon-si (KR); Jong-kil KWAK, Suwon-si (KR); Su-gun KIM, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/103,909

(22) Filed: Apr. 16, 2008

(30) Foreign Application Priority Data
Aug. 22, 2007 (KR) 10-2007-0084619

(51) Int. Cl. G02F 1/13357; F21V 5/02

(52) U.S. Cl. 349/62; 362/268; 362/237

(57) ABSTRACT

A backlight unit and an image display module are provided. The backlight unit includes a micro-lens unit, and a light source unit, wherein the direction in which the plurality of lenses are arranged is at an oblique angle relative to the direction in which the plurality of light sources are arranged. Accordingly, uniform brightness is provided to a display apparatus.

### CROSS-REFERENCE TO RELATED APPLICATIONS

This application claims priority under 35 U.S.C. §119 from Korean Patent Application No. 10-2007-0084619, filed on Aug. 22, 2007, in the Korean Intellectual Property Office, the disclosure of which is incorporated herein by reference in its entirety.

### BACKGROUND OF THE INVENTION

1. Field of the Invention

Apparatuses and methods consistent with the present invention relate to a backlight unit and an image display module, and arranging the backlight unit, and more particularly, to a backlight unit which emits backlight onto a liquid crystal panel.

2. Description of the Related Art

A liquid crystal display (LCD) apparatus is a display apparatus for acquiring a desired image signal by applying an electric field to a liquid crystal material having an anisotropic dielectric constant which is inserted between two electrodes, and adjusting the amount of light penetrating the electrodes by adjusting the strength of the electric field.

The LCD apparatus consists of a liquid crystal panel and a backlight unit. The backlight unit generates light, and the liquid crystal panel displays images by adjusting the amount of penetration of light generated by the backlight unit.

FIG. 1 shows the backlight unit. As shown in FIG. 1, the backlight unit includes a lenticular lens sheet 10, and a light source unit 20. The lenticular lens sheet 10 includes aligned cylindrical lenses 15, and the light source unit 20 includes a plurality of point light sources 25 which are arrayed in a matrix shape.

The lenticular lens sheet 10 and the light source unit 20 are arranged so that the direction of the cylindrical axes of the lenticular lens sheet 10 is identical to the direction of column of the light source unit 20.

However, if the lenticular lens sheet 10 and the light source unit 20 are arranged as shown in FIG. 1, the brightness is not distributed uniformly, and dark lines are generated. Accordingly, users view images having inconsistent brightness, and accordingly may experience eye fatigue if they view images for a long time.

Therefore, there is a need for a display apparatus having uniform brightness.

### SUMMARY OF THE INVENTION

Exemplary embodiments of the present invention address at least the above problems and/or disadvantages and other disadvantages not described above. Also, the present invention is not required to overcome the disadvantages described above, and an exemplary embodiment of the present invention may not overcome any of the problems described above.

The present invention provides a backlight unit in which lenses are arranged at an oblique angle relative to the light sources, and an image display module to provide uniform brightness to a display apparatus.

According to an exemplary aspect of the present invention, there is provided a backlight unit including: a micro-lens unit which comprises a plurality of lenses; and a light source unit which comprises a plurality of light sources, wherein the direction in which the plurality of lenses are arranged is at an oblique angle relative to the direction in which the plurality of lenses are arranged.

The direction in which the plurality of lenses are arranged is at an oblique angle ranging from 7° to 38° relative to the direction in which the plurality of light sources are arranged.

The plurality of lenses may be lenticular lenses, and the direction in which the plurality of lenses are arranged is the axial direction of cylindrical lenses constituting the lenticular lenses.

The micro-lens unit may comprise a plurality of circular lenses arranged in a matrix form, and the direction in which the plurality of circular lenses are arranged is the direction of rows or columns of the matrix form.

The micro-lens unit may include a plurality of oval lenses arranged in a matrix form, and the direction in which the plurality of oval lenses are arranged is the major-axial direction of the oval lens.

The light source unit may include a plurality of point light sources arranged in a matrix form, and the direction in which the plurality of the point light sources are arranged is the direction of row or columns of the matrix form.

The light source unit may include a plurality of line light sources arranged in rows or columns, and the direction in which the plurality of the line light sources are arranged is the cylindrical axial direction of the line light source.

The direction in which the plurality of lenses are arranged may be at an oblique angle relative to the direction in which the plurality of light sources are arranged due to rotation of the micro-lens unit on the basis of a display.

The direction in which the plurality of lenses are arranged may be at an oblique angle relative to the direction in which the plurality of light sources are arranged is due to the rotation of the light source unit on the basis of a display.

According to another exemplary aspect of the present invention, there is provided an image display module including a panel on which an image is displayed; and a backlight unit which radiates backlight onto the panel, wherein the backlight unit comprises a micro-lens unit which comprises a plurality of lenses, and a light source unit which comprises a plurality of light sources, wherein the direction in which the plurality of lenses are arranged is at an oblique angle relative to the direction in which the plurality of light sources are arranged.

The direction in which the plurality of lenses are arranged is at an oblique angle ranging from 7° to 38° relative to the direction in which the plurality of light sources are arranged.

The plurality of lenses are lenticular lenses, and the direction in which the plurality of lenses are arranged may be the axial direction of cylindrical lenses constituting the lenticular lenses.

The light source unit may include a plurality of point light sources arranged in a matrix form, and the direction in which the plurality of the point light sources are arranged is the direction of rows and columns of the matrix form.

According to another exemplary aspect of the present invention, there is provided a display apparatus including an image providing unit which provides an image based on an input image signal; a panel on which the image is displayed; and a backlight unit which radiates backlight onto the panel, wherein the backlight unit comprises a micro-lens unit which comprises a plurality of lenses, and a light source unit which comprises a plurality of light sources, wherein the direction in which the plurality of lenses are arranged is at an oblique angle relative to the direction in which the plurality of light sources are arranged.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 shows a conventional backlight unit;

FIG. 2 is a cross-sectional view of an LCD according to an exemplary embodiment of the present invention;

FIG. 3 shows a backlight unit including a lenticular lens sheet and a point light source unit, which is rotated, according to a first exemplary embodiment of the present invention;

FIG. 4 shows a backlight unit including a lenticular lens sheet, which is rotated, and a point light source unit according to the first exemplary embodiment of the present invention;

FIG. 5 shows a backlight unit including an oval lens sheet and a point light source unit, which is rotated, according to a second embodiment of the present invention;

FIG. 6 shows a backlight unit including an oval lens sheet, which is rotated, and a point light source unit according to the second embodiment of the present invention;

FIG. 7 shows a backlight unit including a lenticular lens sheet and a line light source unit, which is rotated, according to a third embodiment of the present invention;

FIG. 8 shows a backlight unit including a lenticular lens sheet, which is rotated, and a line light source unit according to the third embodiment of the present invention;

FIG. 9 shows the results of examining brightness according to the angle between the cylindrical axis of the lenticular lens sheet and the axis of the row direction of the point light source unit according to an exemplary embodiment of the present invention; and

FIG. 10 shows the results of comparing the brightness of a part in which a lenticular lens sheet is arranged at an oblique angle relative to a light source unit and a part in which a lenticular lens sheet is arranged perpendicular to a light source unit, according to an exemplary embodiment of the present invention.

### DETAILED DESCRIPTION OF EXEMPLARY EMBODIMENTS OF THE INVENTION

Certain exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the present invention can be carried out without those specifically defined matters. Also, well-known functions or constructions are not described in excessive detail since they would obscure the invention unnecessarily.

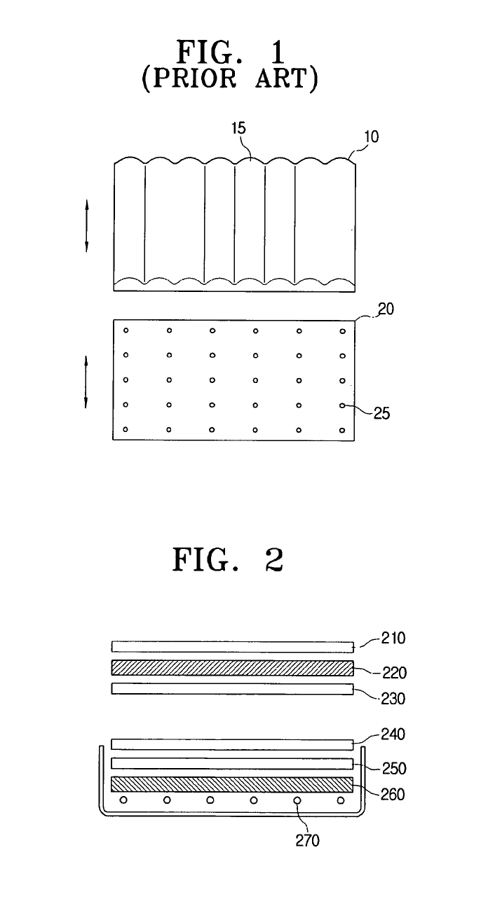

FIG. 2 is a cross-sectional view of an LCD according to an exemplary embodiment of the present invention. The LCD displays images on an LCD panel 220 based on image signals provided by an image providing unit (not shown). Accordingly, an LCD display apparatus includes the LCD, and the image providing unit.

As shown in FIG. 2, the LCD includes an upper polarizing film 210, an LCD panel 220, a lower polarizing film 230, a double bright enhancement film (DBEF) 240, a bright enhancement film (BEF) 250, a lenticular lens sheet 260, and a light source unit 270, which are disposed in sequence. A backlight unit includes the DBEF 240, the BEF 250, the lenticular lens sheet 260, and the light source unit 270.

The upper polarizing film 210 and the lower polarizing film 230 polarize light penetrating the LCD panel 220 in a certain direction. In a normally black mode, the polarizing axis of the upper polarizing film 210 is implemented perpendicular to that of the lower polarizing film 230.

The LCD panel 220 consists of liquid crystal aligned between two transparent electrodes, and is arranged differently according to the voltage applied across the electrodes, resulting in a change in the refractive index. Accordingly, light can pass through in a desired refractive index. In this manner, the LCD panel 220 can generate desired images.

The DBEF 240 and the BEF 250 include a plurality of prism sheets, and focus backlight in a certain polarizing direction.

The lenticular lens sheet 260 includes a plurality of cylindrical lenses aligned, and diffuses backlight to secure a broad field angle of an LCD display. In addition, the lenticular lens sheet 260 may focus backlight on a comparatively dark area, and thus diffuses backlight uniformly.

The lenticular lens sheet 260 is one type of micro-lens sheet. The micro-lens is a fine lens having a diameter ranging from 0.1 mm to 10 mm. The micro-lens sheet is a sheet on which a plurality of micro-lenses are arranged.

Diverse kinds of micro-lens sheets may be used instead in place of the lenticular lens sheet 260. For example, a circular lens sheet including a plurality of circular lenses arranged in a matrix form, or an oval lens sheet including a plurality of oval lenses arranged in a matrix form may be used.

The light source unit 270 includes a plurality of point light sources arranged in a matrix form, and generates and supplies backlight to the LCD panel 220. For example, point light sources of the light source unit 270 may be light emitting diodes (LEDs).

Moreover, the point light sources may be replaced with line light sources or surface light sources. For example, a cold cathode fluorescent lamp (CCFL) may be used as the line light source.

The direction in which the lenticular lens sheet 260 is arranged (that is, the direction in which the lenses are arranged) is different from that of the light source unit 270 (that is, the direction in which the light sources are arranged). In other words, the lenticular lens sheet 260 is arranged at a certain oblique angle relative to the light source unit 270. In particular, the lenticular lens sheet 260 may be arranged at an oblique angle ranging from 7° to 38° relative to the light source unit 270.

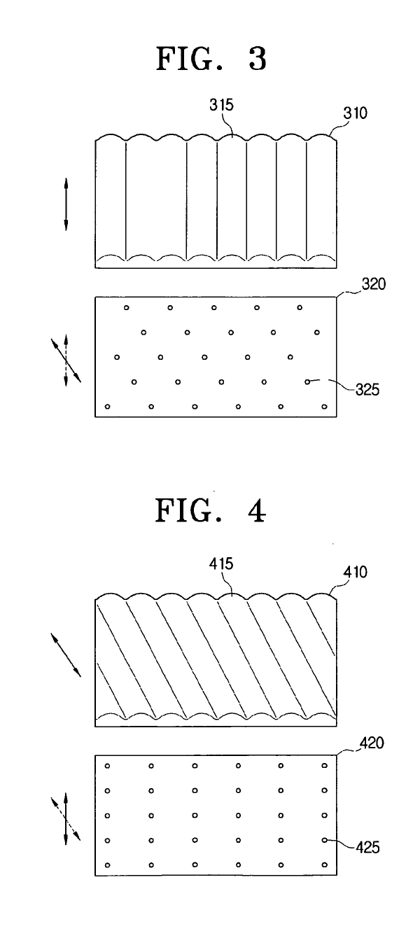

The arrangement of the lenticular lens sheet 260 and the light source unit 270 is described in greater detail with reference to FIGS. 3 and 4.

FIG. 3 shows a backlight unit including a lenticular lens sheet and a point light source unit, which is rotated, according to a first exemplary embodiment of the present invention. The backlight unit includes the lenticular lens sheet 310 and the point light source unit 320.

The direction in which the lenticular lens sheet 310 is arranged (that is, the direction in which the lenses are arranged) is based on the axial direction of the cylindrical lenses 315 constituting the lenticular lens sheet 310. The direction in which the point light source unit 320 including a plurality of point light sources 325 in a matrix form is arranged (that is, the direction in which the light sources are arranged) is the direction of a row or a column of the matrix form. In FIG. 3, the direction in which the point light source unit 320 is arranged is based on a column of the matrix form.

As shown in FIG. 3, the point light source unit 320 is rotated counterclockwise. The direction in which the lenticular lens sheet 310 is arranged is at an oblique angle of the same size as the rotation angle of the point light source unit 320 relative to the direction in which the point light source unit 320 is arranged.

FIG. 4 shows a backlight unit including a lenticular lens sheet 410, which is rotated, and a point light source unit 420 according to the first exemplary embodiment of the present invention. The backlight unit includes the lenticular lens sheet 410 and the point light source unit 420.

The direction in which the lenticular lens sheet 410 is arranged is based on the axial direction of the cylindrical lenses 415 constituting the lenticular lens sheet 410. The direction in which the point light source unit 420 including a plurality of point light sources 425 in a matrix form is arranged is the direction of a row or column of the matrix form. In FIG. 4, the arranged direction of the point light source unit 420 is based on a column of the matrix form.

As shown in FIG. 4, the lenticular lens sheet 410 is rotated counterclockwise. The direction in which the lenticular lens sheet 410 is arranged is at an oblique angle of the same size as the rotation angle of the lenticular lens sheet 410 relative to the direction in which the point light source unit 420 is arranged.

As described above, the direction in which the lenticular lens sheets 310 and 410 are arranged is at an oblique angle relative to the direction in which the point light source units 320 and 420 respectively are arranged due to rotation of the point light source unit 320 or the lenticular lens sheet 410.

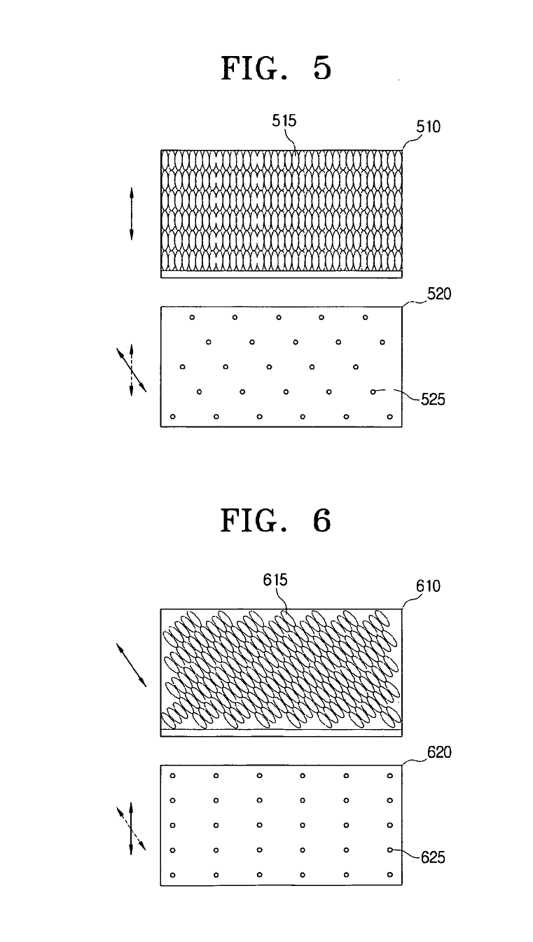

The arrangement of the oval lens sheets 510 and 610 and the point light source units 520 and 620 are described in greater detail with reference to FIGS. 5 and 6.

FIG. 5 shows a backlight unit including an oval lens sheet 510 and a point light source unit 520, which is rotated, according to a second exemplary embodiment of the present invention. The backlight unit includes the oval lens sheet 510 and the point light source unit 520. The oval lens sheet 510 has similar functions to the lenticular lens sheet 410 described above.

The oval lens sheet 510 includes a plurality of oval lenses 515 arranged in a matrix form. The direction in which the oval lens sheet 510 is arranged is based on the major-axial direction of the oval lenses 515 constituting the oval lens sheet 510. The direction in which the point light source unit 520 including a plurality of point light sources 525 in a matrix form is arranged is the direction of a row or a column of the matrix form. In FIG. 5, the direction in which the point light source unit 520 is arranged is based on a column of the matrix form.

As shown in FIG. 5, the point light source unit 520 is rotated counterclockwise. The direction in which the oval lens sheet 510 is arranged is at an oblique angle the same size as the rotation angle of the point light source unit 520 relative to the direction in which the point light source unit 520 is arranged.

FIG. 6 shows a backlight unit including an oval lens sheet 610, which is rotated, and a point light source unit 620 according to the second exemplary embodiment of the present invention.

As shown in FIG. 6, the backlight unit includes the oval lens sheet 610 and the point light source unit 620. The oval lens sheet 610 has similar functions to the lenticular lens sheet 410 described above.

The oval lens sheet 610 includes a plurality of oval lenses 615 arranged in a matrix form. The direction in which the oval lens sheet 610 is arranged is based on the major-axial direction of the oval lenses 615 constituting the oval lens sheet 610. The direction in which the point light source unit 620 including a plurality of point light sources 625 in a matrix form is arranged is the direction of a row or a column of the matrix form. In FIG. 6, the direction in which the point light source unit 620 is arranged is based on a column of the matrix form.

As shown in FIG. 6, the oval lens sheet 610 is rotated counterclockwise. The direction in which the oval lens sheet 610 is arranged is at an oblique angle of the same size as the rotation angle of the oval lens sheet 610 relative to the direction in which the point light source unit 620 is arranged.

As described above, the direction in which the oval lens sheets 510 and 610 are arranged is at an oblique angle relative to the direction in which the point light source units 520 and 620 respectively are arranged due to rotation of the point light source unit 520 or the oval lens sheet 610.

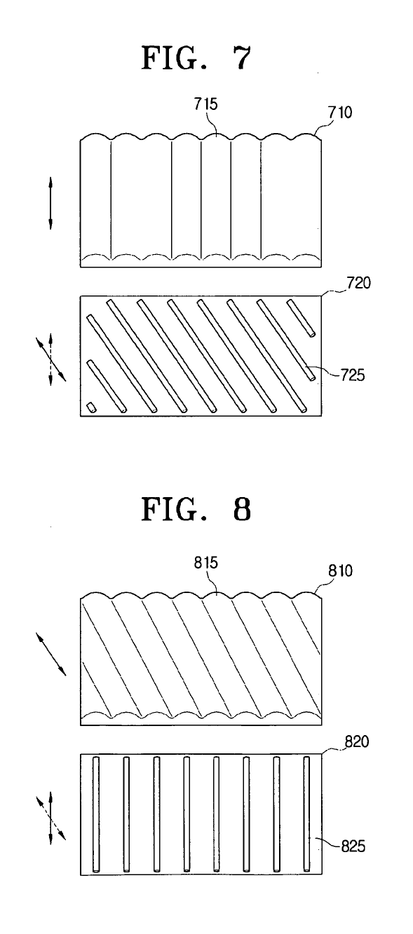

The arrangement of the lenticular lens sheets 710 and 810 and the light source units 720 and 820 are described in greater detail with reference to FIGS. 7 and 8.

FIG. 7 shows a backlight unit including a lenticular lens sheet 710 and a line light source unit 720, which is rotated, according to a third exemplary embodiment of the present invention, and FIG. 8 shows a backlight unit including a lenticular lens sheet 810, which is rotated, and a line light source unit 820 according to the third exemplary embodiment of the present invention.

The third exemplary embodiment of FIGS. 7 and 8 are similar to the first exemplary embodiment of FIGS. 3 and 4, so description of shared aspects of the construction is omitted.

As shown in FIGS. 7 and 8, the point light sources are replaced with the line light sources 725 and 825, which may be cold cathode fluorescent lamps (CCFLs).

The line light source units 720 and 820 include a plurality of respective line light sources 725 and 825 aligned in rows or columns. The direction in which the line light source units 720 and 820 are arranged is based on the cylindrical axis direction of the line light sources 725 and 825. In FIGS. 7 and 8, the direction in which the line light source units 720 and 820 are arranged is aligned in columns.

In FIG. 7, the line light source unit 720 is rotated counterclockwise, and in FIG. 8, the lenticular lens sheet 810 is rotated counterclockwise.

Accordingly, the direction in which the lenticular lens sheets 710 and 810 are arranged is at an oblique angle relative to the direction in which the respective line light source unit 720 and 820 is arranged due to rotation of the line light source unit 720 or the lenticular lens sheet 810.

As described above, a backlight unit in which the lenticular lens sheet or the oval lens sheet is arranged at an oblique angle relative to the point light source or the line light source unit is described with reference to FIGS. 3 to 8.

In the above exemplary embodiments, a lenticular lens sheet or an oval lens sheet is used, but other kinds of micro-lens sheet may also be used. For example, a circular lens sheet may also be applied to the technical idea of the present invention.

In addition, in the above exemplary embodiments, point light sources or line light sources are used, but other kinds of light sources may also be used. For example, surface light sources may be applied to the technical idea of the present invention.

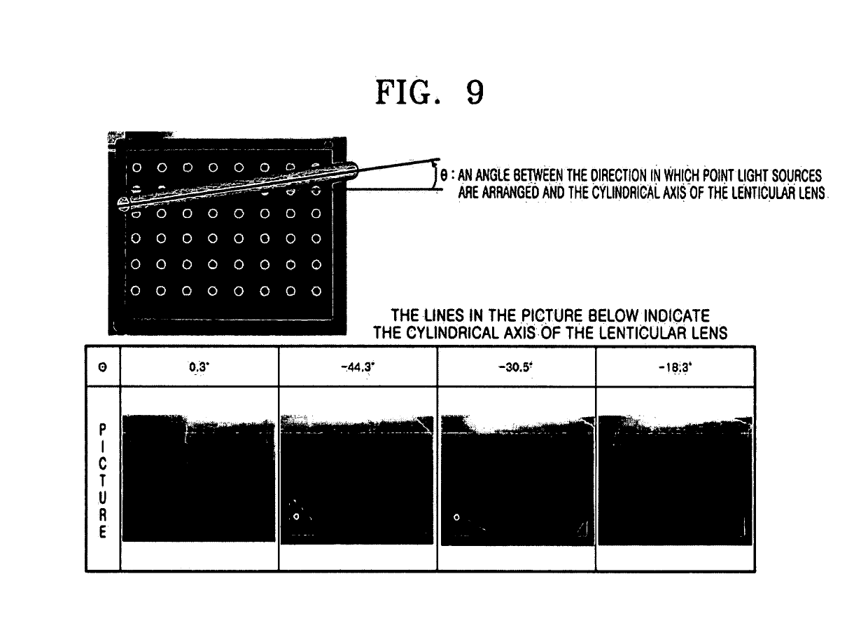

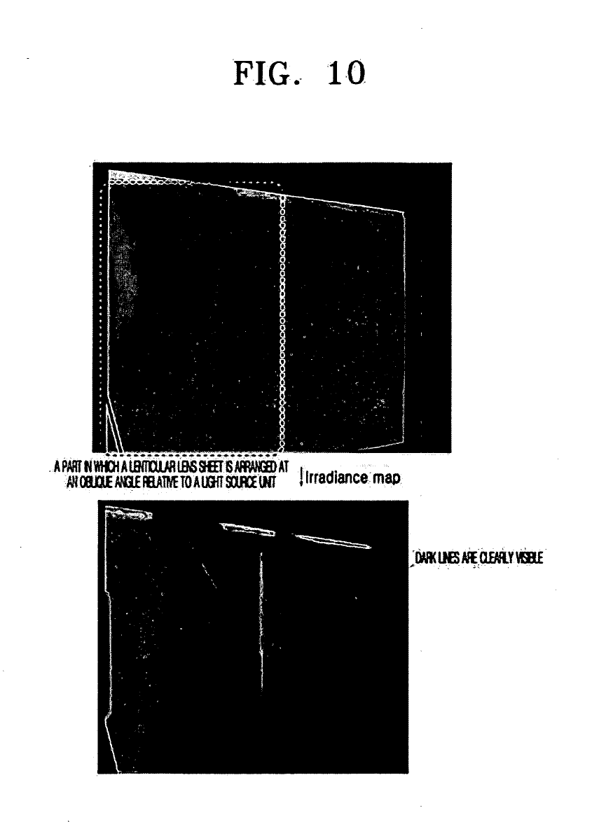

The examination results according to an exemplary embodiment of the present invention are described with reference to FIGS. 9 and 10.

FIG. 9 shows the results of examining brightness according to the angle between the cylindrical axis of the lenticular lens sheet and the axis of the direction of the rows of the point light source unit according to an exemplary embodiment of the present invention.

As shown in the upper drawing of FIG. 9, white circles arranged in a matrix form are displayed on the computer monitor. Additionally, an environment similar to a backlight unit including a lenticular lens sheet and a point light source unit is constructed by disposing a lenticular lens sheet in front of the monitor screen.

If the lenticular lens sheet is rotated in front of the monitor, an effect such as a backlight unit, in which the lenticular lens sheet is arranged at an oblique angle relative to the point light source unit, is implemented.

As described in the table of FIG. 9, pictures captured by examining the form of dark lines generated according to the rotation angle (oblique angle) are shown. The angle θ 0 indicates an angle which the axis of the cylindrical lens of the lenticular lens sheet forms clockwise on the basis of the axis of the direction of the rows of the point light sources on the monitor. The two lines shown on the lenticular lens in FIG. 9 indicates the axis of the cylindrical lens of the lenticular lens.

In the table of FIG. 9, if the angle θ is 0.3°, the direction in which the lenticular lens is arranged is almost parallel to the direction in which the point light source is arranged, so vertical dark lines are generated. If the angle θ is −44.3°, the direction in which the lenticular lens is arranged is at an oblique angle relative to the direction in which the point light source is arranged, but the direction in which the lenticular lens is arranged is almost parallel to the diagonal direction of the point light source, so diagonal dark lines are generated.

If the angle θ is −30.5°, the dark lines are thin. If the angle θ is −18.3°, the dark lines almost disappear, and the brightness is distributed consistently.

Based on the above examination, it is confirmed that if the lenticular lens sheet is arranged at an oblique angle relative to the point light source unit, the dark lines vanish and a uniform level of brightness is acquired. Furthermore, when the angle between the lenticular lens sheet and the point light source unit ranges from 7° to 38°, the level of uniformity of brightness is high.

FIG. 10 shows the results of comparing the brightness of a part in which a lenticular lens sheet is arranged at an oblique angle relative to a light source unit and a part in which a lenticular lens sheet is arranged parallel to a light source unit, according to an exemplary embodiment of the present invention.

In the upper picture of FIG. 10, on the basis of the center of the backlight unit, on the left, a lenticular lens sheet is arranged at an oblique angle relative to a light source unit, and on the right, a lenticular lens sheet is arranged parallel to a light source unit. In this state, a backlight is radiated, and the one performing this experiment observes that as shown in FIG. 10.

The lower picture of FIG. 10 shows the distribution of brightness of light which is applied to the irradiance map in the captured picture. In the picture, there are no dark lines on the left side, but dark lines are generated on the right side.

It is confirmed that if the lenticular lens sheet is arranged at an oblique angle relative to the light sources, the uniformity of brightness is enhanced.

The above exemplary embodiments of the present invention are geared towards LCDs, but may also be applied to other image display modules including a backlight unit.

As can be appreciated from the above description, a backlight unit, in which lenses are arranged at an oblique angle relative to light sources and an image display module are provided, so uniform brightness is achieved in a display apparatus.

In particular, since lenticular lenses are arranged at an oblique angle relative to point light sources, dark lines, which are comparatively dark areas in the backlight, are removed, so the uniformity of the display can be enhanced.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A backlight unit comprising:
a micro-lens unit which comprises a plurality of lenses; and
a light source unit which comprises a plurality of light sources,
wherein a direction in which the plurality of lenses are arranged is at an oblique angle relative to a direction in which the plurality of light sources are arranged.

2. The backlight unit of claim 1, wherein the oblique angle is within a range of 7° to 38° relative to the direction in which the plurality of light sources are arranged.

3. The backlight unit of claim 1, wherein the plurality of lenses are lenticular lenses, and the direction in which the plurality of lenses are arranged is an axial direction of cylindrical lenses constituting the lenticular lenses.

4. The backlight unit of claim 1, wherein the micro-lens unit comprises a plurality of circular lenses arranged in a matrix form, and a direction in which the plurality of circular lenses are arranged is a direction of rows or columns of the matrix form.

5. The backlight unit of claim 1, wherein the micro-lens unit comprises a plurality of oval lenses arranged in a matrix form, and a direction in which the plurality of oval lenses are arranged is a major-axial direction of the oval lenses.

6. The backlight unit of claim 1, wherein the light source unit comprises a plurality of point light sources arranged in a matrix form, and a direction in which the plurality of the point light sources are arranged is a direction of row or columns of the matrix form.

7. The backlight unit of claim 1, wherein the light source unit comprises a plurality of line light sources arranged in rows or columns, and a direction in which the plurality of the line light sources are arranged is a cylindrical axial direction of the line light sources.

8. The backlight unit of claim 1, wherein the direction in which the plurality of lenses are arranged is at the oblique angle relative to the direction in which the plurality of light sources are arranged due to rotation of the micro-lens unit on the basis of a display.

9. The backlight unit of claim 1, wherein the direction in which the plurality of lenses are arranged is at the oblique angle relative to the direction in which the plurality of light sources are arranged is due to the rotation of the light source unit on the basis of a display.

10. An image display module comprising:
a panel on which an image is displayed; and
a backlight unit which radiates backlight onto the panel,
wherein the backlight unit comprises a micro-lens unit which comprises a plurality of lenses, and a light source unit which comprises a plurality of light sources,
wherein a direction in which the plurality of lenses are arranged is at an oblique angle relative to a direction in which the plurality of light sources are arranged.

11. The image display module of claim 10, wherein the oblique angle is within a range of 7° to 38°.

12. The image display module of claim 10, wherein the plurality of lenses are lenticular lenses, and the direction in which the plurality of lenses are arranged is an axial direction of cylindrical lenses constituting the lenticular lenses.

13. The image display module of claim 10, wherein the light source unit comprises a plurality of point light sources arranged in a matrix form, and a direction in which the plurality of the point light sources are arranged is a direction of rows and columns of the matrix form.

14. A display apparatus comprising:
an image providing unit which provides an image based on an input image signal;
a panel on which the image is displayed; and
a backlight unit which radiates backlight onto the panel,
wherein the backlight unit comprises a micro-lens unit which comprises a plurality of lenses, and a light source unit which comprises a plurality of light sources,
wherein a direction in which the plurality of lenses are arranged is at an oblique angle relative to a direction in which the plurality of light sources are arranged.
